(19) United States
(12) Patent Application Publication
(10) Pub. No.: US 2010/0179886 A1
(43) Pub. Date: Jul. 15, 2010

(54) SYSTEM FOR PROVIDING INFORMATION OF A GOODS IN INTERNET SHOPPING MALL AND METHOD THEREOF

(76) Inventor: Seong Won Lee, Seoul (KR)

Correspondence Address: CHRISTOPHER PAUL MITCHELL, 888 16TH ST., NW, SUITE 800, WASHINGTON, DC, 20006, US

(21) Appl. No.: 12/664,842

(22) PCT Filed: Jul. 1, 2008
(86) PCT No.: PCT/KR08/03880

§ 371 Date: Dec. 15, 2009

(30) Foreign Application Priority Data
Jul. 3, 2007 (KR) 10-2007-0066409

(51) Int. Cl. G06F 17/30; G06Q 30/00; G06F 15/16

(52) U.S. Cl. 705/27; 707/802; 709/203; 707/E17.044

(57) ABSTRACT

The present invention relates to a system and method for providing product information for an Internet shopping mall. The system includes a web server (2) for providing various types of information and link regions to a user terminal over an Internet, a DB server (4) for storing information about products, and a display server (3) for displaying information stored in the DB server on a web page. The DB server includes a main product information DB (411) for storing information about a main product, and a main link region information DB (441) for storing information about a link region of the main product. The display server includes a main product display module (311) for displaying information about the main product on the web page in which the main product is displayed when a screen point is located in the link region of the main product.

### TECHNICAL FIELD

The present invention relates to a system and method for providing product information for an Internet shopping mall, which set a link region in a product image displayed on the web page of an Internet shopping mall, and then allow product information or the like to be displayed on the web page through a display module when a screen point is located in the link region, thus allowing a user to conveniently search for product information and easily purchase a product.

### BACKGROUND ART

Recently, Electronic Commerce (EC), enabling transactions conducted to purchase and sell products over the Internet or through PC communication, has been widely used. Such EC originally includes all activities, such as the purchase of products or services, conducted through a communication network, and ordering and advertising activities, under a broad interpretation. A system, the function of which is designated to sell products in EC, is typically called an Internet shopping mall.

As existing advertising methods and systems for products handled in Internet shopping malls, such things as a banner advertisement for causing a user to access a website, go to a new web page, and view detailed information about a relevant product when the user clicks the banner advertisement displayed on the web page, and a pop-up advertisement for causing a separate browser window, which shows advertisement content, to be popped up when a user for the first time accesses a website, have been used.

However, there are problems in that such a banner advertisement is configured to merely provide an image advertisement so as to maintain the recognition of a certain service or brand rather than purchase products or provide product information, and such a pop-up advertisement is unilaterally provided regardless of the user's intention, and thus a unilateral pop-up window, provided to the user's browser that is currently performing a search operation, causes mental displeasure to the user.

Further, even if the user obtains information about a desired product from an Internet shopping mall through a banner advertisement or a pop-up advertisement, the user must perform a click operation several times, must open several pages due to the click operations, and must repeatedly perform the operation of closing a current web page opened by the user and obtaining information about other products to search for other products, and thus there is an inconvenience in its use.

In particular, in the situation in which the number of products to be searched for increases as the number of products handled in Internet shopping malls increases, an operation of opening and closing web pages increases so as to view information about respective products, so that the time required for the user to shop over the Internet is increased. As a result, there is a problem in that information about products displayed on Internet shopping malls cannot be effectively provided to the user.

Further, there is a problem in that existing Internet shopping malls, in which each single product is cursorily described, have a limitation of making it impossible to provide detailed information about products for a great number of displayed products.

Furthermore, when the user desires to purchase a related product, displayed on a web page together with a main product displayed thereon, no information about the related product exists, and thus there is a problem in use in such a way that the user must abandon purchasing the related product, or must separately search for and purchase a related product.

FIG. 1(A)

is a diagram showing an example of a web page in which a ‘buy’ button is fixed in a conventional product details page, and FIG. 1(B) is a diagram showing a web page in which a conventional product details page is vertically aligned.

In the prior art, referring to FIGS. 1(A) and 1(B), a ‘buy’ button is fixed in a portion above a product details page, which provides related information together with the detailed image of a product, and the images of the product are arranged vertically at a length corresponding to several pages and are then vertically aligned. Therefore, when desiring to obtain information about a desired product, the user must open vertically aligned product images using an input means. When desiring to purchase the product after viewing the information about the product, the user must scroll up to the upper portion of the web page using a scroll bar or the like and must click the ‘buy’ button because the ‘buy’ button is fixed in the upper portion of the web page, and thus there is an inconvenience in its use.

### DISCLOSURE

### Technical Problem

Accordingly, the present invention has been made keeping in mind the above problems occurring in the prior art, and an object of the present invention is to provide a system and method for providing product information for an Internet shopping mall, which allow information about a product to be displayed on a web page when a screen point is located in a preset link region even though a user does not open a new web page by clicking an image of a product displayed on an Internet shopping mall using an input means in order to obtain information about the product, thus allowing the user to conveniently and efficiently view information about a desired product.

Another object of the present invention is to provide a system and method for providing product information for an Internet shopping mall, which also set a link region in an image of a related product, displayed together with an image of a main product displayed on the Internet shopping mall and allow information about the related product to be displayed on the web page when a screen point is located in the link region of the related product, in order to obtain information about the related product without performing a separate search operation when the user desires to purchase the related product displayed together with the main product, thus allowing the user to conveniently and efficiently obtain information about desired products and maximizing a seller's profit from sales.

A further object of the present invention is to provide a system and method for providing product information for an Internet shopping mall, which set a link region for each product displayed on the Internet shopping mall, and display a link window for enabling going to a web page, in which a desired product can be purchased, on the Internet shopping mall when a screen point is located in the link region, thus allowing the user to conveniently purchase products.

### Technical Solution

In order to accomplish the above objects, a system and method for product information for an Internet shopping mall according to the present invention comprise the following construction.

According to a first embodiment of the present invention, the present invention provides a system for providing product information for an Internet shopping mall, comprising a web server for providing various types of information and link regions to a user terminal over an Internet, a Database (DB) server for storing information about products, and a display server for displaying information stored in the DB server on a web page, wherein the DB server comprises a main product information DB for storing information about a main product displayed on the web page, and a main link region information DB for storing information about a link region of the main product, and wherein the display server comprises a main product display module for displaying information about the main product, stored in the main product information DB, on the web page in which the main product is displayed when a screen point is located in the link region of the main product stored in the main link region information DB.

According to a second embodiment of the present invention, in the system according to the first embodiment of the present invention, the DB server further comprises a related product information DB for storing information about a related product displayed together with an image of the main product displayed on the web page, and a related link region information DB for storing information about a link region of the related product, and the display server further comprises a related product display module for displaying information about the related product, stored in the related product information DB, on the web page on which the related product is displayed when the screen point is located in the link region of the related product stored in the related link region information DB.

According to a third embodiment of the present invention, in the system according to the first or second embodiment of the present invention, the DB server further comprises a detailed image DB for storing information about a detailed image of the main product or the related product, and the display server further comprises a detailed image display module for displaying information, stored in the detailed image DB, on the web page when the screen point is located in the link region of the main product or the related product.

According to a fourth embodiment of the present invention, in the system according to the third embodiment of the present invention, the DB server further comprises a purchase DB for storing information about a link window for enabling going to a web page, in which the main product or the related product can be purchased, and the display server further comprises a purchase display module for displaying information, stored in the purchase DB, on the web page when the screen point is located in the link region of the main product or the related product.

According to a fifth embodiment of the present invention, in the system according to the fourth embodiment of the present invention, the user terminal comprises a terminal server for transmitting, through the web server, information about a product for which a link window displayed on the web page at a link window display step is clicked using input means, storing the information about the product, and displaying the stored product information on a display screen.

According to a sixth embodiment of the present invention, a system for providing product information for an Internet shopping mall comprises a DB server for storing information about products and a display server for displaying information stored in the DB server on a web page, wherein the DB server comprises a purchase DB for storing information about a link window for enabling going to a web page, in which a desired product can be purchased, and a main link region information DB or a related link region information DB for storing information about a link region of a product set in a predetermined area of the web page, and wherein the display server comprises a purchase display module for displaying information stored in the purchase DB on the web page when a screen point is located in the link region stored in the main link region information DB or the related link region information DB.

According to a seventh embodiment of the present invention, a method of providing product information for an Internet shopping mall according to the present invention comprises a data input step of storing information about a main product or a related product, displayed on a web page, in a main product information DB or a related product information DB, a link region setting step of storing information about a link region of the main product or the related product in a main link region information DB or a related link region information DB, and a display step of, when a screen point is located in the link region of the main product or the related product stored at the link region setting step, displaying the information about the main product or the related product, stored at the data input step, on the web page on which the main product or the related product is displayed through a main product display module or a related product display module.

According to an eighth embodiment of the present invention, in the method according to the seventh embodiment of the present invention, the data input step comprises a link window storage step of storing information about a link window for enabling going to a web page, in which a desired product can be purchased, and the display step comprises a link window display step of, when a screen point is located in a link region of the product stored at the link region setting step, displaying the link window stored at the link window storage step on the web page.

According to a ninth embodiment of the present invention, in the method according to the eighth embodiment of the present invention, the link window display step comprises a click step of clicking the link window, displayed on the web page at the link window display step, using input means, and a search result display step of transmitting information about a product clicked at the click step through a web server, storing the product information in a terminal server, and displaying the information about the clicked product on a display screen.

### ADVANTAGEOUS EFFECTS

The present invention can realize the following advantages through the above-described constructions and connection relationships.

The present invention is advantageous in that information about a product is displayed on a web page when a screen point is located in a preset link region even though a user does not open a new web page by clicking an image of a product displayed on an Internet shopping mall using an input means in order to obtain information about the product, thus allowing the user to conveniently and efficiently view information about a desired product.

The present invention is advantageous in that, in order to obtain information about a related product displayed together with a main product without performing a separate search operation when a user desires to purchase the related product, a link region is also set in an image of the related product, displayed together with an image of the main product displayed on an Internet shopping mall, and then information about the related product is displayed on the web page when a screen point is located in the link region of the related product, thus allowing the user to conveniently and efficiently obtain information about desired products and maximizing a seller's profit from sales.

The present invention is advantageous in that a link region is set for each product displayed on an Internet shopping mall, and a link window for enabling going to a web page, in which a desired product can be purchased, is displayed on the Internet shopping mall when a screen point is located in the link region, thus allowing the user to conveniently purchase products.

### DESCRIPTION OF DRAWINGS

FIG. 1(A) is a diagram showing an example of a web page in which a ‘buy’ button is fixed in a conventional product details page;

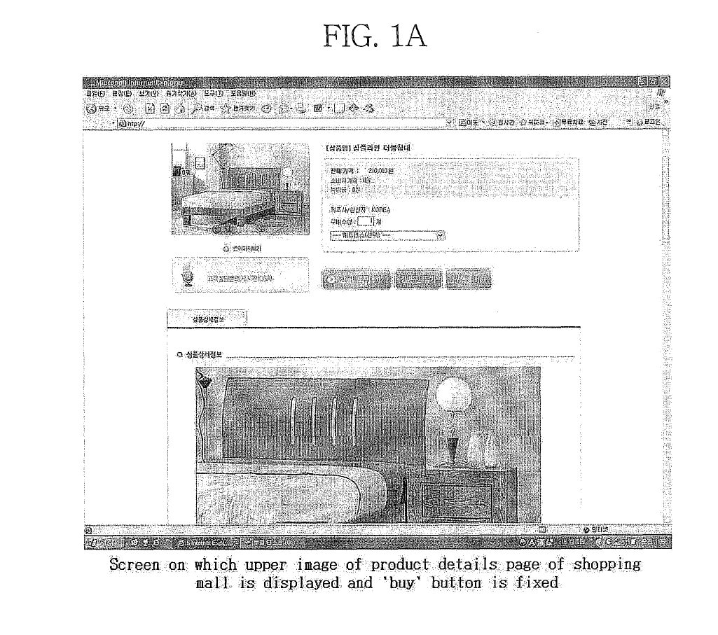

FIG. 1(B) is a diagram showing an example of a web page in which a conventional product details page is vertically aligned;

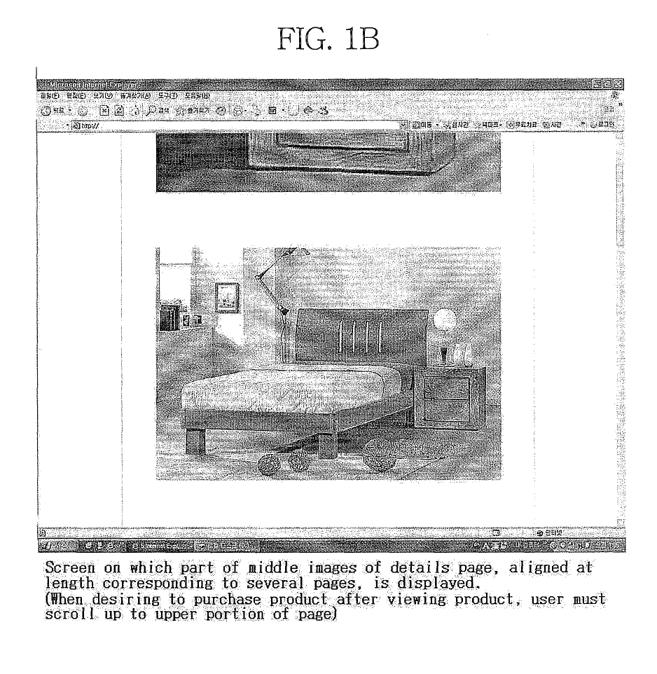

FIG. 2 is a block diagram showing a system for providing product information for an Internet shopping mall according to an embodiment of the present invention;

FIG. 3(A) is a block diagram showing a system for providing product information for an Internet shopping mall according to another embodiment of the present invention;

FIG. 3(B) is a block diagram showing a system for providing product information for an Internet shopping mall according to a further embodiment of the present invention;

FIG. 3(C) is a block diagram showing a system for providing product information for an Internet shopping mall according to yet another embodiment of the present invention;

FIG. 3(D) is a block diagram showing a system for providing product information for an Internet shopping mall according to sill another embodiment of the present invention;

FIG. 4(A) is a diagram showing an example of a web page in which a link region is set for a main product according to the present invention;

FIG. 4(B) is a diagram showing an example of a web page in which link regions are set for a main product and related products according to the present invention;

FIG. 5(A) is a diagram showing an example of a web page on which information about a related product is displayed as text according to the present invention;

FIG. 5(B) is a diagram showing an example of a web page on which information about a related product is displayed as an image according to the present invention;

FIG. 5(C) is a diagram showing an example of a web page on which a link window is displayed according to the present invention;

FIG. 6 is a flow diagram showing a method of providing product information for an Internet shopping mall according to an embodiment of the present invention;

FIG. 7 is a flow diagram showing a method of providing product information for an Internet shopping mall according to another embodiment of the present invention; and

FIG. 8 is a flowchart showing a system for providing product information for an Internet shopping mall according to an embodiment of the present invention.

### DESCRIPTION OF REFERENCE NUMERALS OF PRINCIPAL ELEMENTS IN THE DRAWINGS

1: user terminal 2: web server 3: display server 4: database server
5: Internet 6: web page 11: display screen 12: input means
13: monitor 14: screen point 15: terminal server 33: detailed image display module
34: purchase display module 42: detailed image DB 43: purchase DB
51, 61: link region 62: main product 63: related product 64: link window
311: main product display module 312: related product display module
411: main product information DB 412: related product information DB
S1: web page screen display step S2: data input step S3: link window storage step
S4: link region setting step S5: display step S6: link window display step
S7: click step S8: search result display step S9: going step

### Best Mode

Hereinafter, embodiments of a system for providing product information for an Internet shopping mall according to the present invention will be described in detail with reference to the attached drawings.

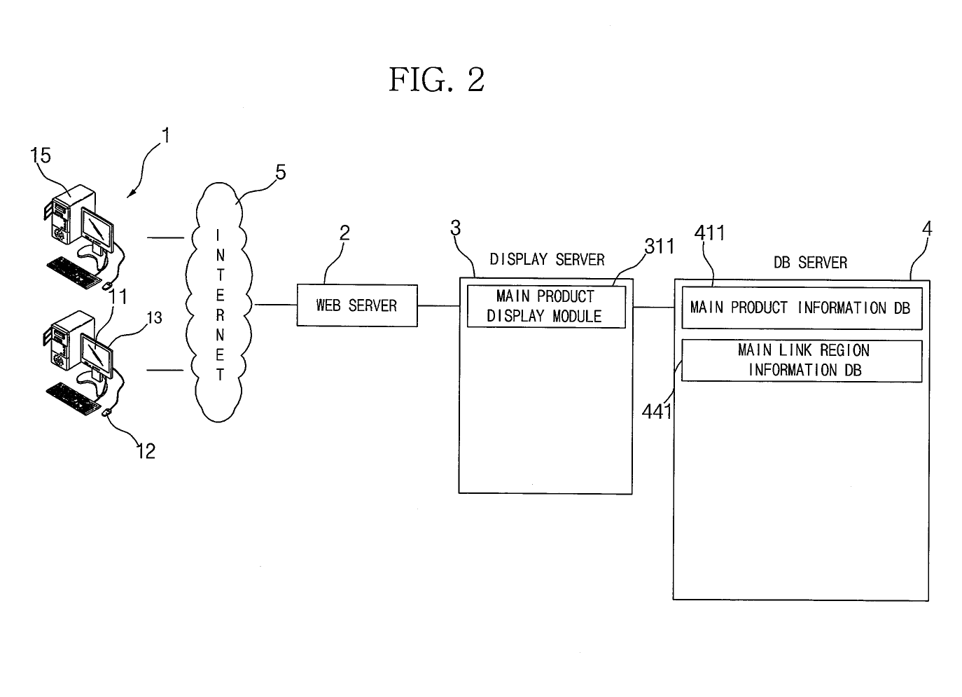

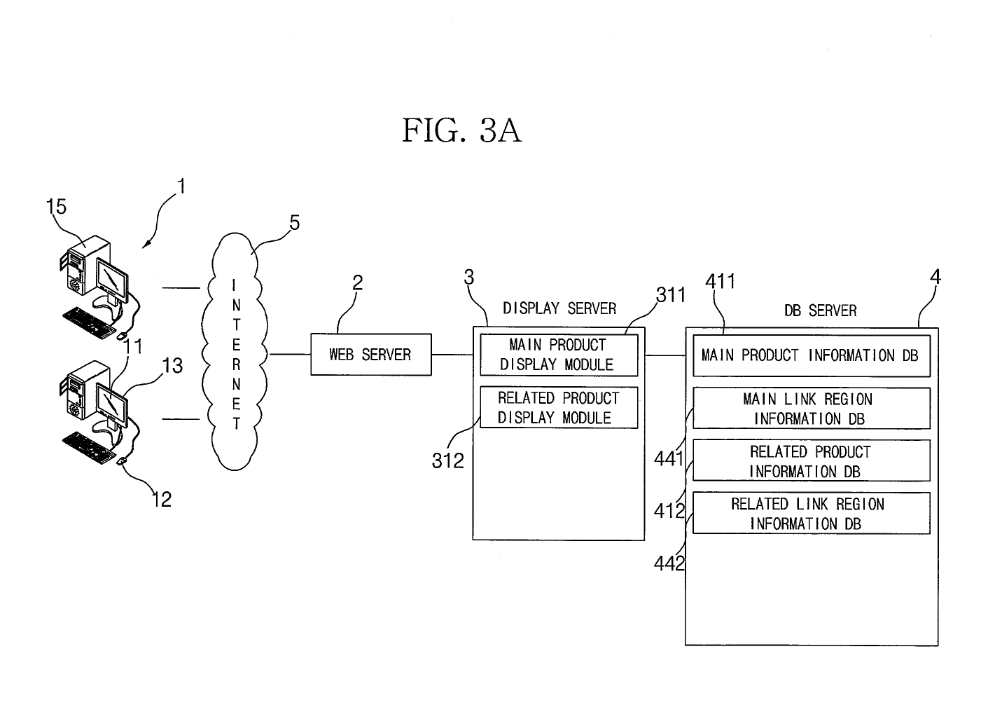

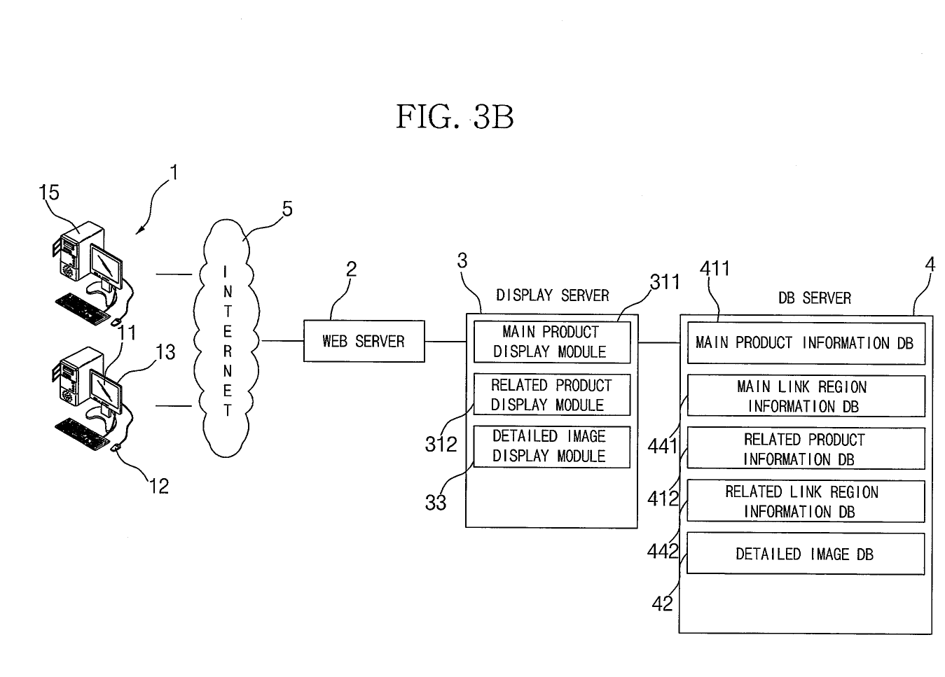

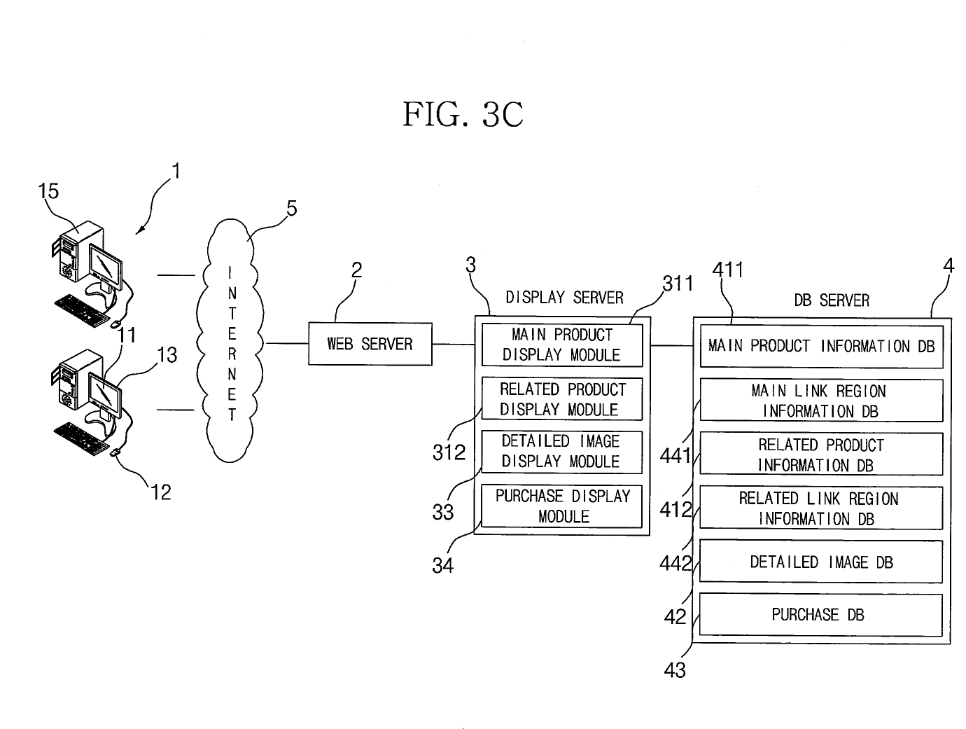

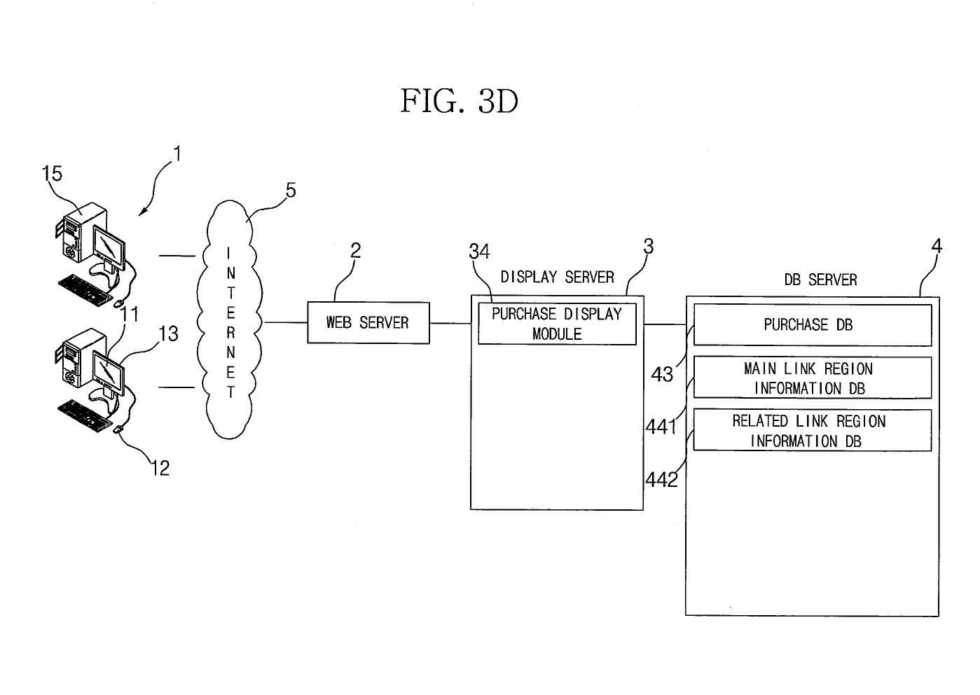

FIG. 2 is a block diagram showing a system for providing product information for an Internet shopping mall according to an embodiment of the present invention, FIG. 3(A) is a block diagram showing a system for providing product information for an Internet shopping mall according to another embodiment of the present invention, and FIGS. 3(B) to 3(D) are block diagrams showing a system for providing product information for an Internet shopping mall according to other embodiments of the present invention.

Referring to FIGS. 2 to 3(D), the system for providing product information for an Internet shopping mall includes a user terminal 1, a web server 2, a web page 6, a database (DB) server 4, and a display server 3.

The user terminal 1 refers to a personal computer, a mobile communication terminal, such as an International Mobile Telecommunication (IMT)-2000 terminal, and a Universal Mobile Telecommunication Service (UMTS) terminal, a Personal Digital Assistant (PDA), a notebook computer, etc., and may preferably be a computer. The user terminal may include an input means 12, a screen point 14, a display screen 11, and a terminal server 15.

The input means 12 denotes all electrical input devices, such as a keyboard, a mouse, a joystick, an electronic pen, a gliding pad, and other input devices, and includes all input devices connected to the user terminal 1 to receive information from the user. Preferably, the input means 12 may be a mouse, which includes a mouse button as a signal generation means.

The screen point 14, which is provided for a Graphic User Interface (GUI), moves in conjunction with the movement of a trackball, provided in the mouse, and a signal generated by the mouse button, and has the function of selecting an entity displayed on the display screen 11. The screen point 14 interfaces with an Operating System (OS) installed in the user terminal 1.

The display screen 11 denotes an electronic medium on which related information or a window can be displayed to allow the user to view the related information or the window, and may preferably be the display screen 13 of a monitor. The screen point 14 is displayed on the display screen 11.

The terminal server 15 receives information about a product for which a link window 64, which will be described later and is transmitted by the web server 2, which will be described later, is clicked, stores the product information, and displays the received information on the display screen 11.

The input means 12, the display screen 11, and the terminal server 15 are components generally used in the art of the present invention, and thus a detailed description thereof is omitted.

The web server 2 transmits the web page 6, on which products are displayed, to the terminal server 15 over the Internet 5, and displays the web page 6 on the display screen 11. The web page 6 is created using a web programming language, and is configured to display products intended to be sold. The components of the web server 2 and the web page 6 are well-known components, and thus a detailed description thereof is omitted by the present applicant.

The DB server 4 is a server for storing product information, such as the prices, places of origin, sizes, names, detailed images, link regions and link windows of products, and may include a product information DB although that is not shown in the drawings.

The product information DB is a component for storing product information, such as the prices, places of origin, sizes and names of products, and includes a main product information DB 411 for storing information about a main product 62 and a related product information DB 412 for storing information about a related product 63.

The products include the main product 62 and the related product 63, wherein the main product 62 refers to each main product for sale or each product for quick sale, and the related product 63 refers to each product related to the main product 62 and configured to improve the functions or aesthetics of the main product 62. The related product 63 is displayed together with an image of a corresponding main product displayed on a web page, thus allowing the user to be conveniently provided with information about the related product 63, together with or separately from the main product 62.

### Mode for Invention

According to another embodiment of the present invention, the DB server 4 further includes a detailed image DB 42.

The detailed image DB 42 stores the detailed images of the main product 62 or the related product 63. The term ‘detailed images’ refers to an enlarged view, a perspective view, a front view, a rear view, and a plan view of each product to be displayed on the web page 6 when a screen point 14 is located in a link region 61, which will be described later, in the image of the product displayed on the web page 6.

According to a further embodiment of the present invention, the DB server 4 further includes a link region information DB although that is not shown in detail in the drawings.

The link region information DB is configured to set a link region 61 for each product displayed on the web page 6 and store the link region 61, and includes a main link region information DB 441 for storing information about the link region 61 of the main product 62, and a related link region information DB 442 for storing information about the link region 61 of the related product 63.

The link region 61 is configured to set a virtual region using a web programming language in a predetermined area of the web page 6, preferably, within the borders of an image of the product displayed on the web page 6, in order to allow the information stored in the DB server 4 to be displayed on the web page 6 through the display server 3, which will be described later, but a method of setting a link region according to the present invention is not limited to this method.

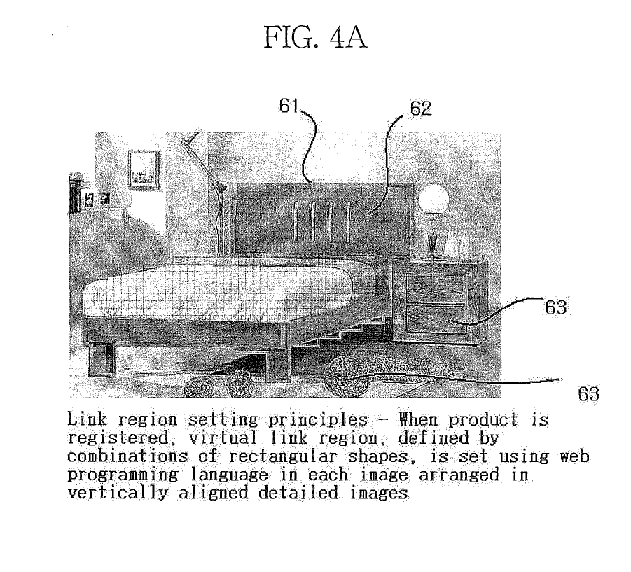

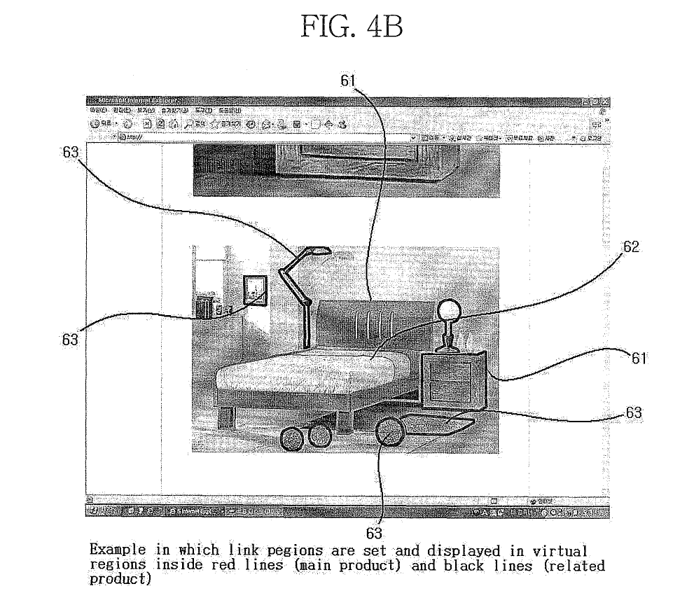

FIG. 4(A) is a diagram showing an example of a web page in which a link region is set for a main product according to the present invention, and FIG. 4b is a diagram showing an example of a web page in which link regions are set for a main product and related products according to the present invention.

Referring to FIG. 4(A), a virtual link region is set using a web programming language in an image of a main product 62, displayed on a web page 6. When a screen point 14 is located in the link region, the information stored in the DB server 4 can be displayed on the web page 6 through the display server 3, which will be described later.

Further, referring to FIG. 4b, a link region 61 is also set for each related product 63, displayed together with the main product 62 displayed on the web page, thus allowing the user to conveniently obtain information about the related product 63 or purchase the related product 63 when the user desires to purchase the related product.

According to yet another embodiment of the present invention, the DB server further includes a purchase DB.

The purchase DB 43 stores information about a link window 64, which functions as a link means for enabling going to a corresponding web page in which a desired product can be purchased. The link window 64 may be displayed as text or an image, and may be preferably displayed as text.

Although not shown in the drawing, the display server 3 is a server for displaying information stored in the DB server 4 on the web page 6 when the screen point 14 is located in the link region 61, and includes a product display module.

The product display module is a module for displaying information about products on the web page, and includes a main product display module 311 and a related product display module 312.

The main product display module 311 is configured to display information about the main product 62, stored in the main product information DB 411, on the web page 6 when the screen point 14 is located in the link region 61 of the main product 62 stored in the main link region information DB 441.

The related product display module 312 is configured to display information about a related product 63, stored in the related product information DB 412, on the web page when the screen point 14 is located in the link region 61 of the related product 63 stored in the related link region information DB 442.

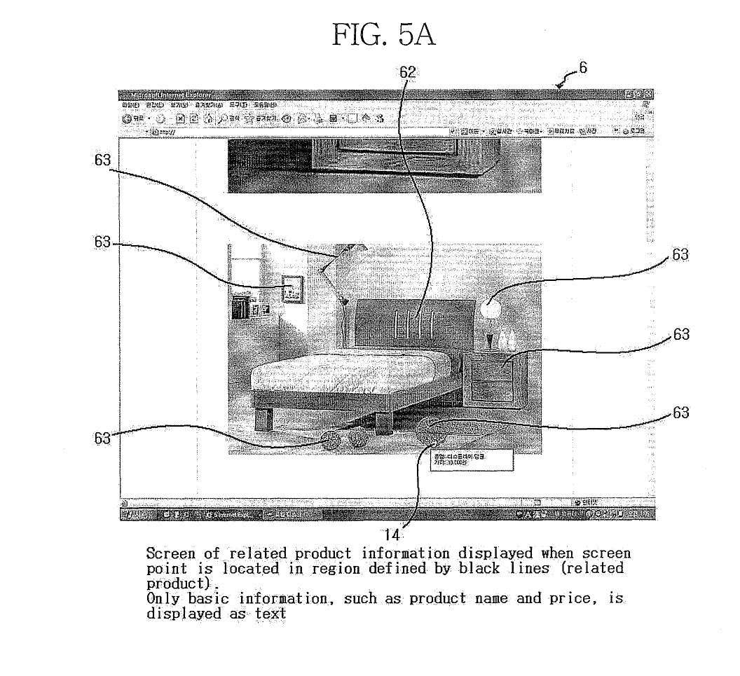

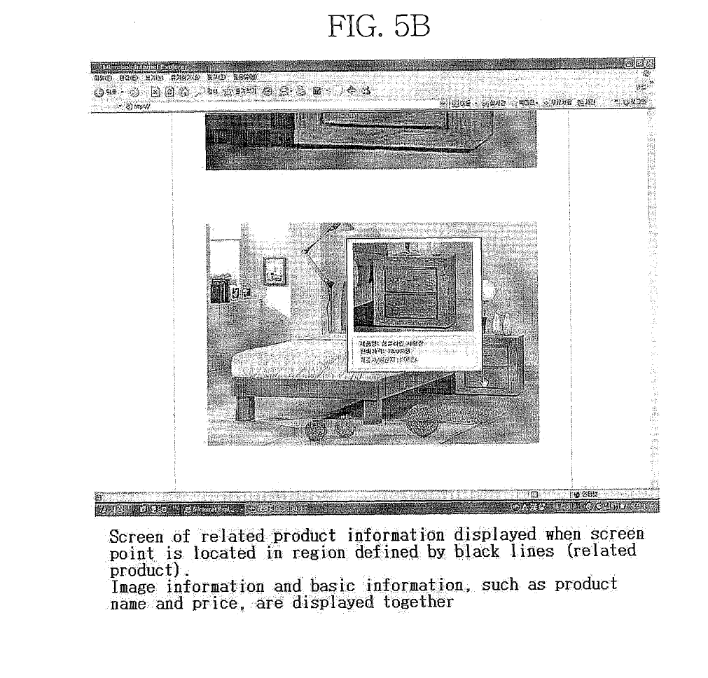

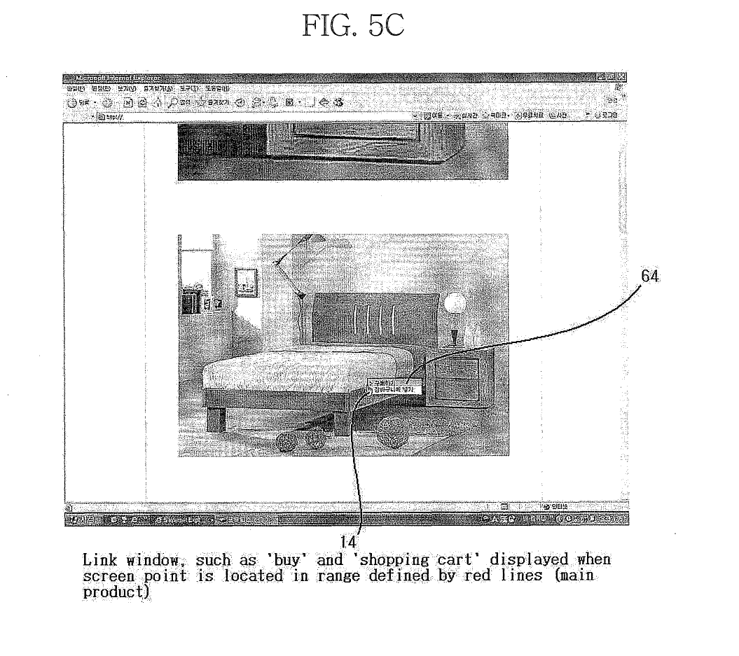

FIG. 5(A) is a diagram showing an example of a web page on which information about a related product is displayed as text according to the present invention.

Referring to FIG. 5(A), when the screen point 14 is located in the link region 61 of the related product 63, only basic related product information, such as the name and price of a related product, may be displayed as text, but information about a related product and a method of displaying the related product information on the web page are not limited to these examples.

According to still another embodiment of the present invention, the display server 3 further includes a detailed image display module 33.

The detailed image display module 33 is configured to display information about the detailed image, stored in the detailed image DB 42, on the web page as a picture or a moving image when the screen point 14 is located in the link region 61 of the main product or the related product. Further, when the detailed image can be displayed on the web page, the present invention does not exclude a scheme in which a detailed image is displayed using various methods, such as a method of displaying a detailed image on the web page together with product information, in addition to the method of displaying only the detailed image on the web page. Further, the present invention does not exclude a scheme in which the detailed image display module 33 displays a product details page, which provides together a detailed image of a product and related information, on the web page when the link region 61 of the main product 62 or the related product 63, in which the screen point 14 is located, is clicked using the input means 12.

FIG. 5(B) is a diagram showing an example of a web page on which information about a related product is displayed as an image according to the present invention.

Referring to FIG. 5(B), it can be seen that, when the screen point is located in the link region of a related product, an enlarged view of the related product and the name, price, manufacturing company and origin of the related product can be displayed together.

FIG. 5(C) is a diagram showing an example of a web page on which a link window 64 is displayed according to the present invention.

According to still another embodiment of the present invention, the display server 3 further includes a purchase display module. The purchase display module 34 is configured to display a link window 64, stored in the purchase DB 43, on the web page when the screen point 14 is located in the link region 61 stored in the main link region information DB 441 or the related link region information DB 442. Therefore, since the link window 64 for enabling going to a web page, in which a desired product can be purchased, is displayed for each product for which the link region 61 is set, the user can conveniently purchase the main product or the related product. Further, referring to FIG. 5(C), the present invention does not exclude a scheme in which a link window 64 for enabling going to a new web page, in which products viewed by the user can be summarized and displayed, is displayed together with the existing link window 64 for enabling going to a new web page in which a desired product can be purchased, in addition to the existing link window 64 being displayed alone, thus allowing the user to select a desired link window.

In particular, when respective images of a product are vertically aligned lengthwise on a single web page, link windows 64 for enabling going to a web page in which the product can be purchased, are displayed for respective images that are vertically aligned lengthwise on the web page, so that the user can go to the corresponding web page, in which the product can be purchased, immediately after obtaining information about the product, thus providing convenience and efficiency to the user.

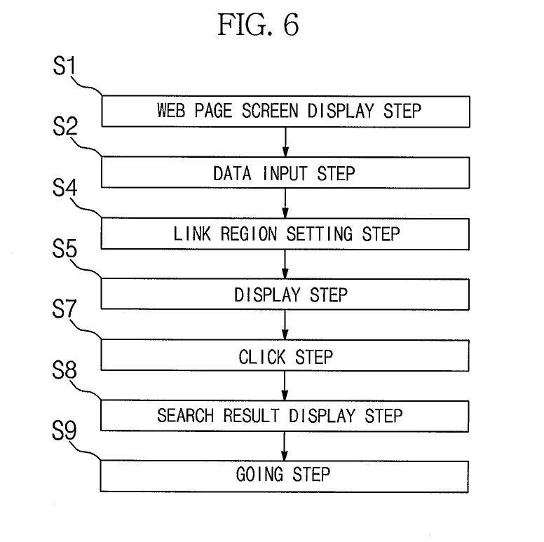

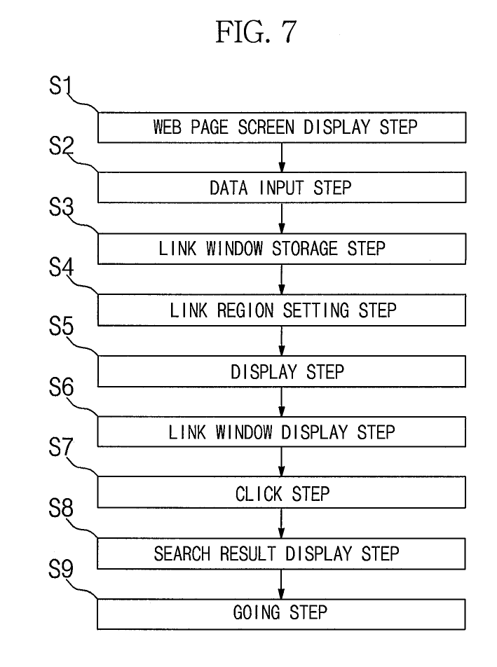

FIG. 6 is a flow diagram showing a method of providing product information for an Internet shopping mall according to an embodiment of the present invention, and FIG. 7 is a flow diagram showing a method of providing product information for an Internet shopping mall according to another embodiment of the present invention.

Referring to FIG. 6, the method of providing product information for an Internet shopping mall according to the present invention includes a web page screen display step S1, a data input step S2, a link region setting step S4, a display step S5, a click step S7, a search result display step S8, and a going step S9.

The web page screen display step S1 is the step of the web server 2 displaying the web page on the display screen 11 of the user terminal when the user accesses the Internet 5 by executing the web browser provided in the user terminal 1, and enters the Uniform Resource Locator (URL) of the web page, which provides information about products, in the web browser.

The data input step S2 is the step of storing information about products, displayed on the web page, in the DB server 4, wherein the information about the products may include information about the names, prices, and places of origin of products, and information about the detailed images of the products, such as the perspective views, enlarged views, front views, rear views and plan views of the products, but the product information is not limited to such examples.

According to another embodiment of the present invention, the data input step S2 includes a link window storage step S3. At the link window storage step S3, information about a link window 64 for enabling going to a web page, in which a desired product can be purchased, is stored.

The link region setting step S4 is the step of setting a link region 61 in a predetermined area of the web page using a web programming language and storing the link region in the DB server 4 so that information about the product can be displayed. The step S4 is performed to set the link region 61 in such a way that a link region 61 is also set for a related product, displayed together with the main product displayed on the web page, thus allowing the user to conveniently obtain information about the related product or purchase the related product when the user desires to purchase the related product.

The display step S5 is the step of, when the screen point 14 is located in the link region 61 of the main product or the related product, stored at the link region setting step S4, displaying the information about the main product or the related product, stored at the data input step S2, on the web page.

According to a further embodiment of the present invention, the display step includes a link window display step S6. The link window display step S6 is the step of, when the screen point 14 is located in the link region of a product, stored at the link region setting step S4, displaying the link window 64, stored at the link window storage step S3, on the web page.

The click step S7 is the step of going to a corresponding web page by clicking the link window 64, displayed on the web page at the link window display step S6, using the input means 12.

The search result display step S8 is the step of storing information about the product, clicked using the input means 12 at the click step S7, in the terminal server 15, which is included in the user terminal 1, through the web server 2, and displaying the information about the product, clicked using the input means 12, on the display screen.

Hereinafter, the present applicant intends to describe the operating relationships between the above-described embodiments of the present invention in detail.

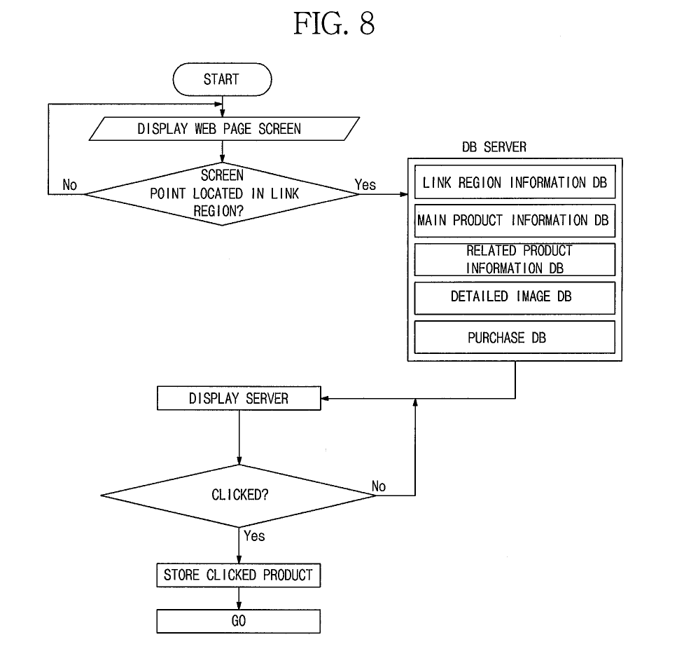

FIG. 8 is a flowchart showing a system for providing product information for an Internet shopping mall according to an embodiment of the present invention.

The system for providing product information for an Internet shopping mall will be described below with reference to FIG. 8. In order for the user to be provided with product information in an Internet shopping mall using the user terminal, a web page on which products are displayed is displayed on the display screen through the web server. When the screen point, having received a signal from the input means of the user terminal, is located in the link region of a product, product information or a detailed image stored in the product information DB or the detailed image DB, which is included in the DB server, is displayed on the web page through the product display module or the detailed image display module. When the screen point is not located in the link region of the product, a web page screen is displayed.

The flow of the system for providing product information for an Internet shopping mall according to another embodiment of the present invention includes a purchase DB for storing a link window for enabling going to a web page, in which a desired product can be purchased, in the DB server. Accordingly, the system is configured such that, when the screen point is located in the link region, the link window is displayed on the web page through the display server, and such that, when the link window displayed on the web page is clicked, information about the clicked product is stored in the terminal server of the user terminal through the web server and is displayed on the display screen of the user terminal.

### INDUSTRIAL APPLICABILITY

Since the present invention allows a user to conveniently and efficiently view product information for an Internet shopping mall so as to obtain information about products in the Internet shopping mall industry, the user can obtain information about a related product without performing a separate search operation to obtain information about the related product. Accordingly, the user can conveniently and efficiently obtain information about a desired product, so that the convenience of sellers and consumers can be realized in the shopping malls, thereby contributing to the online shopping mall industry and maximizing sellers' profit from sales.

1. A system for providing product information for an Internet shopping mall, comprising:
a web server for providing various types of information and link regions to a user terminal over an Internet;
a Database (DB) server for storing information about products; and
a display server for displaying information stored in the DB server on a web page,
wherein the DB server comprises a main product information DB for storing information about a main product displayed on the web page, a main link region information DB for storing information about a link region of the main product, a related product information DB for storing information about a related product displayed together with an image of the main product displayed on the web page, and a related link region information DB for storing information about a link region of the related product; and
wherein the display server comprises a main product display module for displaying information about the main product, stored in the main product information DB, on the web page in which the main product is displayed when a screen point is located in the link region of the main product stored in the main link region information DB, and a related product display module for displaying information about the related product, stored in the related product information DB, on the web page on which the related product is displayed when the screen point is located in the link region of the related product stored in the related link region information DB.

2. The system according to claim 1, wherein:
the DB server further comprises a detailed image DB for storing information about a detailed image of the main product or the related product; and
the display server further comprises a detailed image display module for displaying information, stored in the detailed image DB, on the web page when the screen point is located in the link region of the main product or the related product.

3. The system according to claim 2, wherein:
the DB server further comprises a purchase DB for storing information about a link window for enabling going to a web page, in which the main product or the related product can be purchased; and
the display server further comprises a purchase display module for displaying information, stored in the purchase DB, on the web page when the screen point is located in the link region of the main product or the related product.

4. The system according to claim 3, wherein the user terminal comprises a terminal server for transmitting, through the web server, information about a product for which a link window displayed on the web page at a link window display step is clicked using input means, storing the information about the product, and displaying the stored product information on a display screen.

5. A method of providing product information for an Internet shopping mall, the method being implemented by the system for providing product information for an Internet shopping mall according to claim 1, comprising:
a data input step of storing information about a main product or a related product, displayed on a web page, in a main product information DB or a related product information DB;
a link region setting step of storing information about a link region of the main product or the related product in a main link region information DB or a related link region information DB; and
a display step of, when a screen point is located in the link region of the main product or the related product stored at the link region setting step, displaying the information about the main product or the related product, stored at the data input step, on the web page on which the main product or the related product is displayed through a main product display module or a related product display module.

6. The method according to claim 5, wherein:
the data input step comprises a link window storage step of storing information about a link window for enabling going to a web page, in which a desired product can be purchased; and
the display step comprises a link window display step of, when a screen point is located in a link region of the product stored at the link region setting step, displaying the link window stored at the link window storage step on the web page.

7. The method according to claim 6, wherein the link window display step comprises:
a click step of clicking the link window, displayed on the web page at the link window display step, using input means; and
a search result display step of transmitting information about a product clicked at the click step through a web server, storing the product information in a terminal server, and displaying the information about the clicked product on a display screen.
